(19) United States
(12) Patent Application Publication
(10) Pub. No.: US 2024/0351046 A1
(43) Pub. Date: Oct. 24, 2024

(54) SCREENING BUCKET

(71) Applicant: SCAIP S.P.A., Parma (IT)

(72) Inventor: Gian Paolo DONDI, Parma (IT)

(73) Assignee: SCAIP S.P.A., Parma (IT)

(21) Appl. No.: 18/595,477

(22) Filed: Mar. 5, 2024

(30) Foreign Application Priority Data
Mar. 6, 2023 (IT) 102023000004080

(51) Int. Cl. B02C 4/02; B02C 4/30; B02C 4/42; B02C 23/16

(52) U.S. Cl. CPC B02C 4/02; B02C 4/30; B02C 4/42; B02C 23/16; B02C 2023/165

(57) ABSTRACT

A bucket for screening, and/or crushing and/or mixing and/or sorting, of an excavating or loading machine, includes a containment body for collecting and containing the material to be treated, and a plurality of working rotors through which the material to be treated passes, configured to rotate about their axis of symmetry, by means of power transmission means. The rotor includes a first and a second end portion mechanically integral with the body of which at least one is operatively connected to the power transmission means and further comprises a screening drum removably connected to the first and second end portions.

### FIELD OF THE INVENTION

This invention fits into the field of buckets for screening, and/or crushing and/or mixing, and/or sorting material e.g. taken from the ground.

These buckets are, for example, configured to be mounted on excavators.

### STATE OF THE ART

Excavators with screening buckets are known to be used, for example, to screen and/or crush and/or mix material in pipe-laying, forestry, mining or general construction applications.

In particular, this bucket can be used for burying pipelines, placed in a respective trench in the ground, such as gas, oil, water or other pipelines, and in particular for covering said pipeline with a corresponding material.

For example, in the construction of pipelines, the ground is generally dug to create a ditch in which pipes are placed to form said pipelines.

Usually part of the material, excavated from the ground to create the ditch, is later reused to cover the pipes.

Preferably, this material is a treated material
i.e. screened or appropriately crushed, so as not to damage the pipeline or create hollow areas around the pipeline, and preferably consists of the excavated material from the pipeline laying excavation.

By screening or crushing, larger components, such as rocks or boulders, which could damage the pipes themselves or prevent the soil above the pipeline from being properly compacted, are removed.

In the state of the art, buckets that can be installed on excavators are known to cover said pipeline with a corresponding material, in particular a treated material.

Known buckets are configured for collecting and containing the material to be treated and generally comprise a plurality of rotors through which said material passes to be treated.

Screening and/or crushing and/or mixing and/or sorting takes place by rotating the rotors about their axis of symmetry.

Generally, the rotors consist of a shaft on which a plurality of screening plates are installed.

The shaft is pivotally attached to two opposing flanks of the bucket body.

The shaft is secured by bearings, for example, and the shaft protrudes out of one or both flanks to be connected by appropriate power transmission means.

Said transmission mean are, in fact, generally placed outside the body of the bucket to prevent damage or soiling when coming into contact with the material to be screened.

The transmission means may include gears or pinions, or pulleys mounted on the end of said shaft and connected for example by chains or belts to a dedicated drive.

It should be noted that due to the harsh conditions in which the rotors work, frequent maintenance is necessary to replace damaged or worn parts such as the screening plates or other mechanical parts that may have been damaged during contact with stones, rocks or dust.

To service said rotors and replace the plates if necessary, the rotors must be removed from the bucket body.

To do this, it is first necessary to remove all the gears mounted on the shaft, then the bearings that support the shaft, and slide said shaft out of one flank, inserting it further into the opposing flank until it is pulled out of the first flank and then tilted and pulled out of the second flank as well.

This therefore involves a series of complex and time-consuming operations, which have to be repeated back-to-back to reassemble the rotors after servicing.

Similarly, the problem arises when it is necessary to make a rotor format change, for example to change the size of the outlet screen.

A known document EP2204501 describes a screening bucket in which the screening rotors are mounted by means of bearings on the sides of the bucket's material receiving body.

In order to improve rotor disassembly, rotor receiving slots are provided on said flanks that extend to the end of the flanks so that the rotor shaft can be slid out together with the bearings through said slots.

This solution allows for simplified disassembly compared to the previous one, but still complex as it still requires the gears mounted on the shaft to be removed first, then the bearings to be unscrewed from the flanks. The same applies to reassembly.

It is therefore still a matter of rotor engagement/disengagement that requires time-consuming and cumbersome operations.

### SUMMARY

The technical problem underlying the present invention is that of making available a screening bucket which is structurally and functionally designed to overcome one or more of the limits set out above with reference to the known prior art.

In the context of the aforementioned problem, one of the main objects of the invention is to develop a screening bucket that can simplify the assembly and disassembly of the parts of working rotors most subject to wear.

A further object of the invention is also that of making available to the art a screening bucket in the context of a simple, rational solution with a rather low cost.

In particular, the invention provides a screening and/or crushing and/or mixing and/or sorting bucket of an excavating or loading machine, comprising a containment body adapted to collect and contain the material to be treated, and a plurality of working rotors through which the material to be treated passes.

Preferably, said rotors are configured to rotate about their axis of symmetry by means of power transmission means.

Preferably said rotor comprises a first and a second end portion mechanically integral with the body.

In particular, at least one of said first or second end portions is operatively connected to the power transmission means.

Preferably said rotor further comprises a screening drum removably connected to said first and second end portions.

Thanks to this solution, the screening drum can be fitted/removed without necessarily disassembling the entire rotor.

Preferably, said rotor comprises two connection elements for mechanically blocking/releasing the screening drum at the first and/or second end portions, respectively.

This provides a simple and cost-effective solution for mounting/disassembling the screening drum.

Preferably the containment body comprises two side flanks and at least one lower wall defining an inner chamber adapted to contain the material to be screened.

Said inner chamber preferably comprises an inlet opening to receive the material and an outlet opening to discharge the screened material.

Preferably, the screening drum comprises a shaft contained in the inner chamber, preferably located near the outlet opening.

Preferably a plurality of plates with constant pitch are installed on said shaft.

In particular the rotors are arranged so that the plates of each drum interpenetrate with those of the adjacent drum.

Preferably, the shaft comprises a central body on which the plates are installed and two lateral extensions that protrude from the outermost plates.

These lateral extensions preferably have a smaller cross-section than the cross-section of the central body.

Preferably such plates comprise a plurality of lobes.

In particular, they comprise a preferably central hole configured to be threaded and positioned along the shaft.

Preferably, these plates are threaded into the shaft and mechanically blocked in the axial direction.

Preferably, said plates are spaced from one another by the intermediate insertion of a spacer defining the pitch of said plates.

Preferably the first and second end portions are passed through the side flanks extending both inside and outside the chamber.

In particular the first and second end portions comprise a pivot arranged passing through the side flank (so as to extend both inside and outside the chamber).

Preferably said pivot is supported by a bearing installed on the side flanks.

Preferably said bearing is installed outside the chamber.

Preferably the pivot is configured to be rotated by the power transmission means.

Preferably said power transmission means are installed on the containment body and placed outside the inner chamber.

In this way, the most delicate parts are not in contact with the waste material taken from the bucket.

Preferably the connecting element is placed inside the chamber.

Preferably the connecting element is a clamp which can be opened into a first and second half-clamp.

Preferably said clamp is configured to embrace the pivot and the facing extension of the shaft.

In particular the clamp includes clamping means for connecting and securing the first and second half-clamps to each other.

Preferably the clamp comprises an inner cavity.

Preferably the clamp comprises on its outside one or more secondary half-plates preferably in pitch continuity with the plates.

Preferably said secondary half-plates have the same shape as the plates, but are divided into two being installed on the first and second half-clamps of the opening clamp respectively.

Preferably the clamp comprises two sections with different outer diameters and wherein the one with a larger outer diameter is placed in the vicinity of the side flanks and the one with a smaller outer diameter is configured for mounting the secondary half-plates.

The invention also relates to the method for mounting a drum in a bucket, which involves inserting two first half-clamps one on the first end portion and one on the second end portion.

The drum is preferably positioned so that the shaft extensions are inserted into each first half-clamp.

Preferably, the second half-clamp is positioned and locked to the first half-clamp.

Said method preferably involves inserting the first half-clamp with the inner cavity facing towards the inside of the inner chamber and preferably involves rotating it by 180° so that the inner cavity faces outwards before the drum is mounted.

Such and other objects are achieved thanks to the characteristics of the invention set forth below.

Said objects and advantages are all obtained by the screening bucket, according to the present invention, as set forth in the appended claims.

### BRIEF DESCRIPTION OF THE DRAWINGS

These and other features will be more apparent from the following description of certain embodiments illustrated by way of non-limiting example in the accompanying drawings.

FIG. 1a: illustrates a rear view of a bucket comprising complete working rotors;

FIG. 1b: illustrates a side view of a bucket comprising complete working rotors;

FIG. 2a: illustrates a front view of a bucket in which the first and second end portions of the working rotors are installed with the first half-clamp, but without drums;

FIG. 2b: illustrates a side view of a bucket in which the first and second end portions of the working rotors are installed with the first half-clamp, but without drums;

FIG. 3: illustrates a front view of a bucket in which the first and second end portions of the working rotors are installed, without connecting elements and without drums;

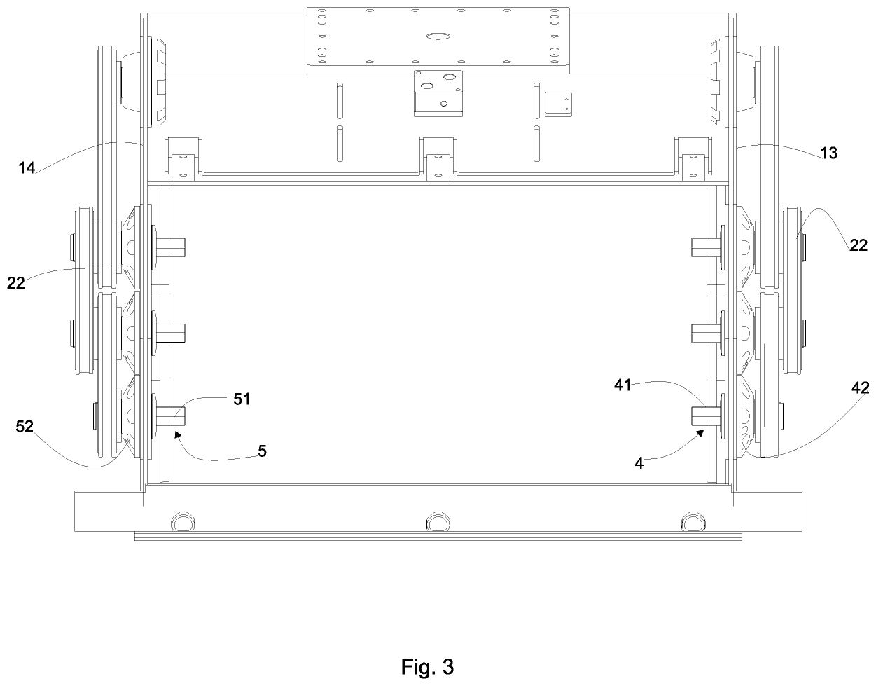

FIG. 4: illustrates a detail of a bucket in a mounting step in which an end portion of the rotors and the first half-clamp are installed, but without drums;

FIG. 5: illustrates a front view of a bucket in a mounting step in which an end portion of the rotors, the first half-clamp and the drum are installed;

FIG. 6a: illustrates an axonometric view of a drum with plates welded to the shaft;

FIG. 6b: illustrates an axonometric view of a drum with plates mechanically locked to the shaft;

FIG. 7a, 7b: illustrates two axonometric views of the first and second half-clamps.

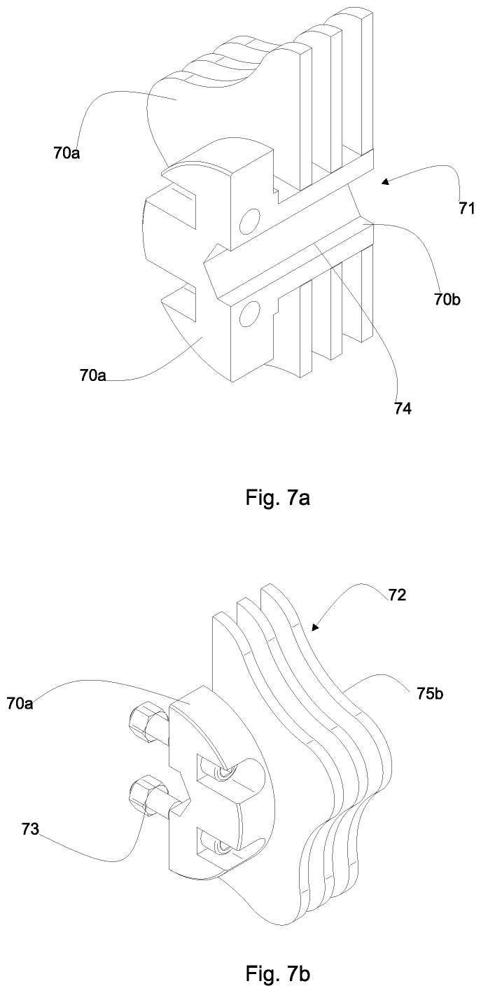

### DETAILED DESCRIPTION OF THE PREFERRED EMBODIMENTS

With particular reference to the figures, a screening and/or crushing and/or mixing and/or sorting bucket 100 of an excavating or loading machine is shown.

The material to be treated is generally taken from the ground and consists of the waste material from the excavation, e.g. for the laying of pipelines.

The bucket 100 may be suitable for covering this pipeline with the corresponding material, preferably consisting of the waste material from the excavation of the pipeline.

In the following we will always talk about a screening bucket 100, i.e. one that performs the function of separating larger components, such as rocks or boulders, which could damage the pipes themselves or not allow the soil above the pipeline to be properly compacted.

When screening, the bucket 100 can also perform the function of crushing the material taken out to make it suitable for reuse, for example for covering pipelines.

Said bucket 100 can also perform the function of mixing the material collected.

In the following, for simplicity's sake, we will talk about the screening bucket 100 and screened or treated material, although these terms also include the functions of crushing, sorting, and mixing.

According to a preferred embodiment, the bucket 100 comprises a containment body 1 for collecting and containing the material to be treated.

Preferably said containment body 1 comprises two side flanks 13, 14 and at least one lower wall 15 defining an inner chamber 10 for containing the material to be screened.

Preferably said containment body 1 further comprises an upper wall 16 that also delimits the inner chamber 10 at the top, in order to better retain the material collected.

In particular, said chamber 10 comprises an inlet opening 11 for receiving the material and an outlet opening 12 for discharging the screened material.

A possible configuration of the containment body 1 is shown in the figures.

Preferably said bucket 100 comprises a plurality of working rotors 3 through which the material to be treated passes.

In particular, said rotors 3 are configured to rotate about their axis of symmetry X.

As can be seen in the figure, said rotors 3 are arranged inside the containment body 1 preferably near the outlet opening 12.

Said rotors 3 are preferably arranged transverse to the side flanks 13, 14, i.e., with the axis of symmetry X orthogonal to the two side flanks 13, 14.

The rotation of the rotors 3, preferably takes place by means of power transmission means 2.

According to an embodiment, said rotor 3 comprises a first and a second end portion 4, 5 mechanically integral with the body 1.

Preferably at least one of said first or second end portion 4, 5 is operatively connected to the power transmission means 2.

In the embodiment depicted in the figures, both the first and second end portions 4, 5 are connected to the power transmission means 2.

According to an advantageous embodiment, the power transmission means 2 are installed on the containment body 1 and placed outside the inner chamber 10, so that they do not come into contact with the material to be treated.

Specifically in the figures, the power transmission means 2 comprise two drives 21 preferably arranged one on each side of the containment body 1. Said drives 21 can be hydraulic or electric motors or other possible drives 21 known to be suitable for the application.

Further, the power transmission means 2 comprise transmission elements 22 such as belts, chains, or gears, which engage in respective pulleys or crowns, or pinions.

Said transmission elements 22 engage with all the working rotors 3 to rotate them all.

In the solution shown in the figure, said transmission elements 22 operatively connect each drive from one side of the containment body 1 to the first end portion 4 of each rotor 3, and from the other side of the containment body 1 to the second end portion 5, of each rotor 3.

We will not go into detail on the possible configurations and arrangement of the transmission elements 22 as they are known to a person skilled in the art and in any case fall within the scope of protection of the invention. The figure shows an example in which the transmission elements 22 are chain links connecting pairs of rotors 3.

The solution with two drives 21 allows high power to be transferred to the working rotors 3, distributing it to both end portions 4, 5.

This reduces the torsional stress to which said working rotor 3 is subjected.

A possible alternative solution could involve a single drive on one side of the containment body 1 or central with a through-shaft.

In such a case, the solution may include transmission elements 22 that engage with both the first and second end portions 4, 5 of each rotor 3.

According to an advantageous embodiment, the working rotor 3 comprises a screening drum 30 removably connected to said first and second end portions 4, 5.

Advantageously, said rotor 3 comprises two connection elements 7 for mechanically blocking/releasing the screening drum 30 at the first and/or second end portions, 4, 5 respectively.

Said connection elements 7 are preferably placed inside the chamber 10 and are described in detail below.

An advantageous aspect of the invention is that the first and second end portions 4, 5 of the working rotor 3 are passed through the side flanks 13, 14 extending both inside and outside the chamber 10.

In particular said first and second end portions 4, 5 comprise a pivot 41, 51 arranged passing through the side flank 13, 14 so as to extend both inside and outside the chamber 10.

Preferably said pivot 41, 51 is supported by a bearing 42, 52 installed on the side flanks 13, 14.

As shown in the figure, said bearing 42, 52 is preferably installed outside the chamber 10, to be less susceptible to contact with the material to be treated.

A preferred embodiment depicted in the figure involves the pivot 41, 51 having a hexagonal cross-section at least in the portion extending towards the inside of the chamber 10.

The advantage of these features will be better highlighted below.

Said pivot 41, 51 is configured to be rotated by the power transmission means 2.

Preferably the portion of said pivot 41, 51 extending outwards from the chamber 10 is configured to support a transmission element 22 such as a pulley, or pinion, etc.

According to a preferred embodiment, the screening drum 30 comprises a shaft 31 completely contained inside the inner chamber 10 and preferably placed near the outlet opening 12.

Therefore, the shaft 31 does not protrude from side flanks 13, 14.

According to an aspect of the invention a plurality of plates 35 are installed on said shaft 31, preferably at a constant pitch, i.e. at a constant distance.

The pitch of the plates acts as a screen to only allow material smaller than the pitch size to pass through.

In particular, the rotors 3 are arranged so that the plates 35 of each drum 30 interpenetrate with those of the adjacent drum 30.

Thanks to these, the screening step is reduced and the material can be crushed.

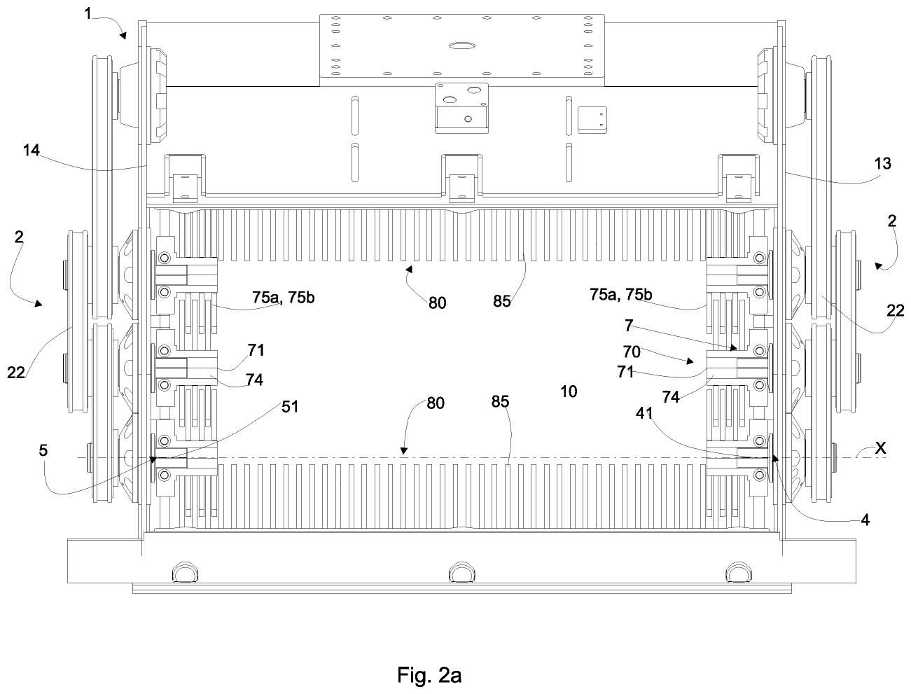

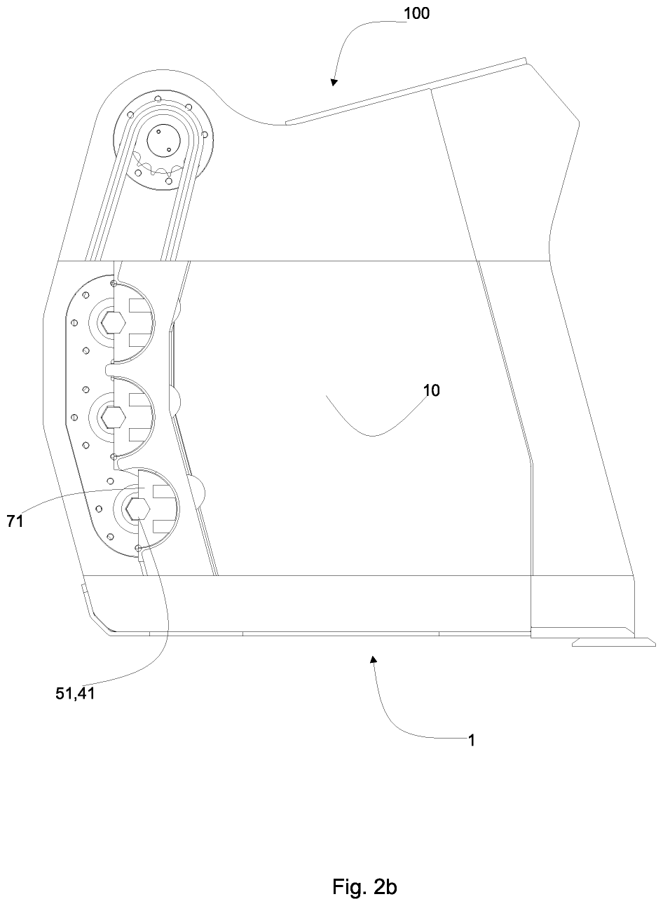

According to an embodiment, the bucket 100 may comprise one or more combs 80. Said combs 80 as depicted in FIG. 2a, can be mounted in the containment body 1 preferably at the lower wall 15 and the upper wall 16.

Said combs 80 comprise a plurality of fixed plates 85 mechanically locked to the containment body 1 and arranged at a constant distance from one other.

The distance between the fixed plates 85 defines the size to be screened.

The shape and distance of the fixed plates 85 is configured to allow for the interpenetration of the plates 35 of the outermost rotors 3.

Said combs 80 have the function of screening the area where the rotors 3 would not otherwise work.

Said combs 80 can be replaced according to the size to be screened.

In particular, the combs 80 are mounted before the rotors 3 and are disassembled after the rotors 3.

Said plates 35 can be of various types. The figures show a preferred type of plate 35 comprising a plurality of lobes.

The shape of the lobes is designed to maximize sorting and separation of the agglomerated soil material. In essence, for maximum efficiency.

Said plates 35 in particular comprise a hole 37 preferably central having the same conformation as the shaft 31 in order to be threaded and positioned along the shaft 31.

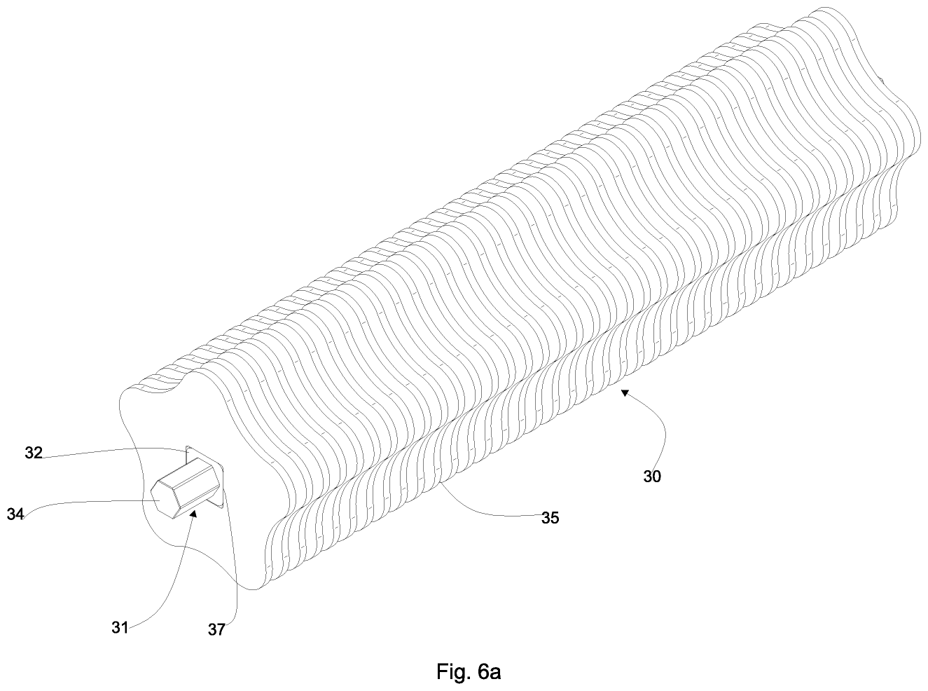

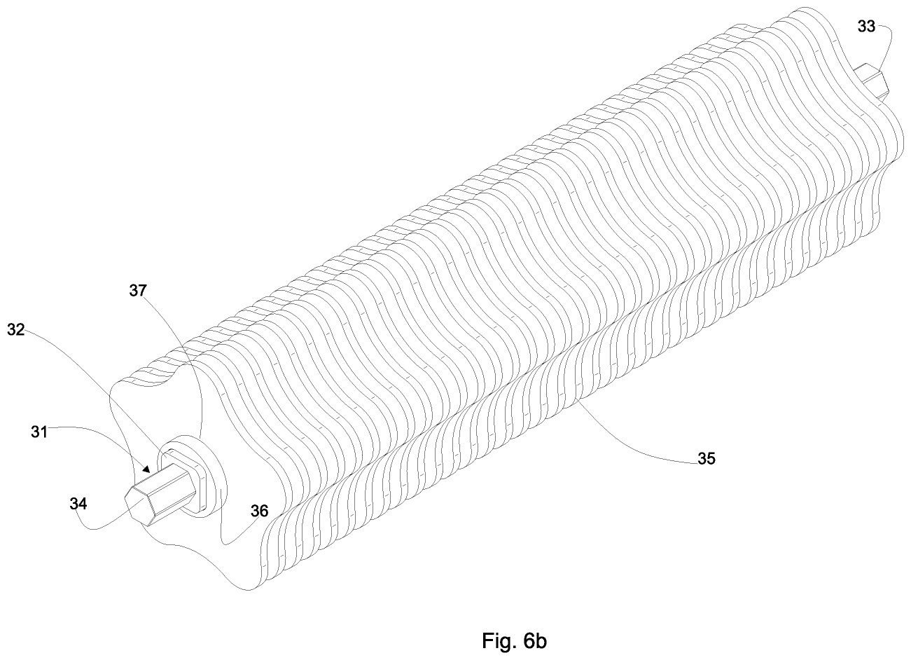

Said plates 35 once positioned on shaft 31 can be welded to the shaft 31 as shown in FIG. 6a.

An alternative solution may involve mechanically locking said plates 35, as shown in FIG. 6b.

The plates 35 of FIG. 6b in particular are threaded into the shaft 31 and spaced apart from each other by the intermediate insertion of a spacer 36 defining the pitch of said plates 35.

Locking the end plates 35 axially blocks any axial sliding of the plates 35.

This solution of mounting the plates 35 in a non-welded manner has the advantage of simplifying the replacement of any plates 35 that may be damaged during work, without having to replace the entire drum 30.

In particular, the shaft 31 comprises a central body 32 on which said plates 35 are installed and two lateral extensions 33, 34 protruding from the outermost plates 35.

Preferably the central body 32 has a square cross-section.

This conformation is particularly advantageous if the plates 35 are mounted as in FIG. 6b without being welded to the shaft.

In fact, thanks to the fact that the central body 32 has a non-round, e.g. square, cross-section, it acts as an anti-rotation device in that rotation of the plates 35 is prevented without the need for additional elements such as tabs or keys.

The fact that the central body has a square cross-section is just one example, but it could also be hexagonal or at least have a flattened portion that allows a corresponding plate 35 to be coupled with a hole 37 having the same cross-section to create the anti-rotation effect.

Preferably the central body 32 is hollow to reduce the overall weight of the bucket 100.

Preferably the lateral extensions 33, 34 are welded to said central body 32.

Preferably the two lateral extensions 33, 34 have a smaller cross-section than the cross-section of the central body 32.

A preferred embodiment is for the two lateral extensions 33, 34 to have a preferably hexagonal cross-section.

The advantage of these features will be better highlighted below.

According to an aspect of the invention, the connection element 7 is an opening clamp 70 comprising a first half-clamp 71 and a second half-clamp 72.

A preferred embodiment depicted in the figure provides for the clamp 70 to be internally hollow, i.e. comprising an inner cavity 74 configured to simultaneously embrace the pivot 41, 51 of the first and second end portions 4, 5 and the facing extension 33, 34 of the shaft 31.

Said clamp 70 as depicted in the figure comprises clamping means 73 for connecting and securing the first half-clamp 71 and the second half-clamp 72 to each other.

Said clamping means 73 can be used to lock/release the screening drum 30 at the first and/or second end portions 4, 5, i.e., the mounting/disassembly of the drum 30 from the rotor 3.

Preferably outside said clamp 70, one or more secondary half-plates 75a, 75b are installed, preferably in pitch continuity with the plates 35.

Preferably said secondary half-plates 75a, 75b, they have the same shape as the plates 35, but are divided into two being installed on the first half-clamp 71 and second half-clamp 72 respectively.

By joining the first half-clamp 71 and the second half-clamp 72, said secondary half-plates 75a, 75b define a single plate similar to or the same as the plates 35 installed on the shaft 31.

Further preferably said clamp 70 is hollow with a hexagonal inner section. The shape of the inner section must be such that it can simultaneously receive and engage with the pivot 41, 51 and the facing extension 33, 34 of the shaft 31.

The choice of the hexagonal section is only a non-limiting example.

However, the presence in the section of at least one flat face, instead of a round section, is intended to act as an anti-rotation between the clamp 70 and the pivot 41, 51 and the extension 33, 34.

Due to the high working torques at play transmitted by the power transmission means 2 to the rotor 3, the use of a clamp 70 configured to work only by friction, i.e. only exploiting the clamping of the clamping means 73, it would slip on the pivot 41, 51 or on the extension 33, 34.

As shown in the figure, the clamp 70 preferably comprises two sections 70a, 70b with different outer diameters.

Preferably the section 70a, with a larger outer diameter is placed near the side flanks 13, 14. This provides a greater bearing surface on the side flank 13, 14 and therefore a more stable attachment.

Additionally, preferably the section 70b with a smaller outer diameter is configured for mounting the secondary half-plates 75a, 75b.

Said secondary half-plates 75a, 75b are preferably welded to the first and/or second half-clamps 71, 72.

This solution therefore simplifies the mounting and disassembly of the screening drum 30, the part most subject to wear and maintenance of the bucket 100.

In fact, the method of mounting/disassembling the drum 30 according to the present invention allows a number of small and simple operations to be performed which do not involve disconnecting or disassembling the bearings 42, 52 or the power transmission means 2.

In fact, this method for mounting a drum 30 on the bucket 100 involves inserting two first half-clamps 71 one on the first end portion 4 and one on the second end portion 5.

In particular, said first half-clamps 71 can be inserted in such a way that they present the cavity 74 directly facing the outside of the inner chamber 10.

To do this, care must be taken to position the secondary half-plates 75a of the first half-clamps 71 between the plates 35 of the adjacent drums 30 of other rotors 3.

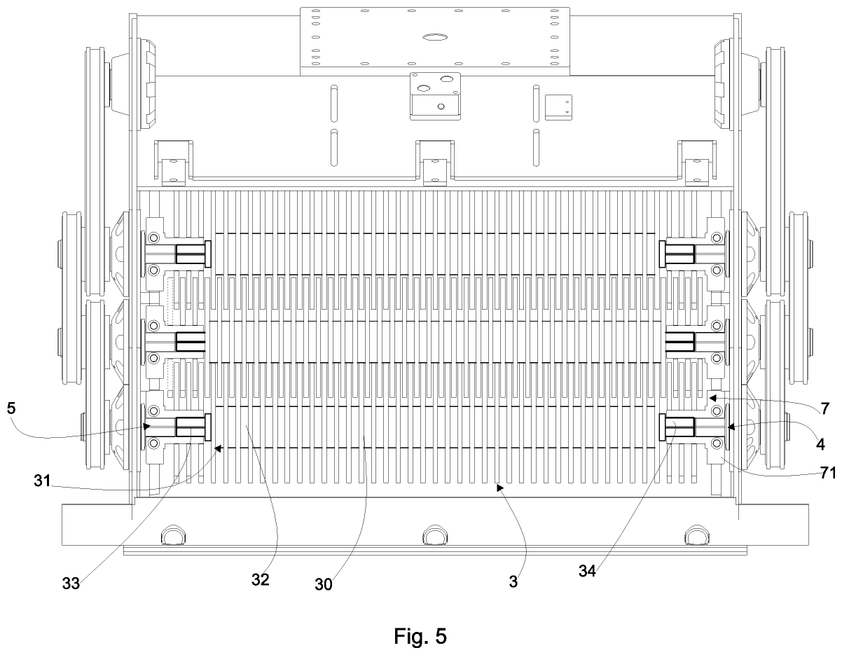

The drum 30 is thus positioned so that the extensions 33, 34 are inserted into said first half-clamps 71, as depicted in FIG. 5.

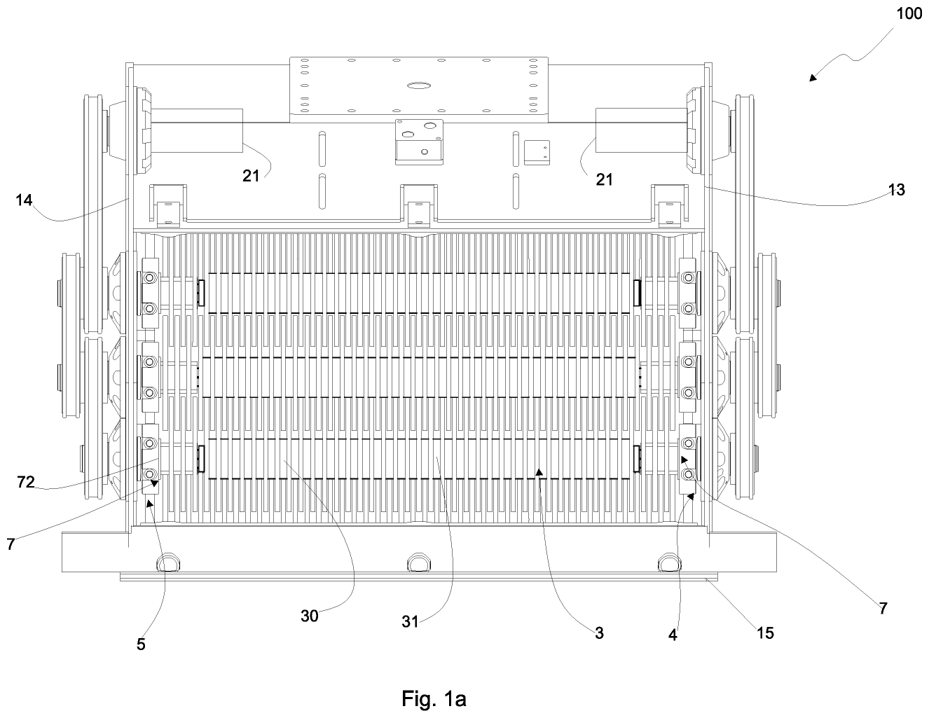

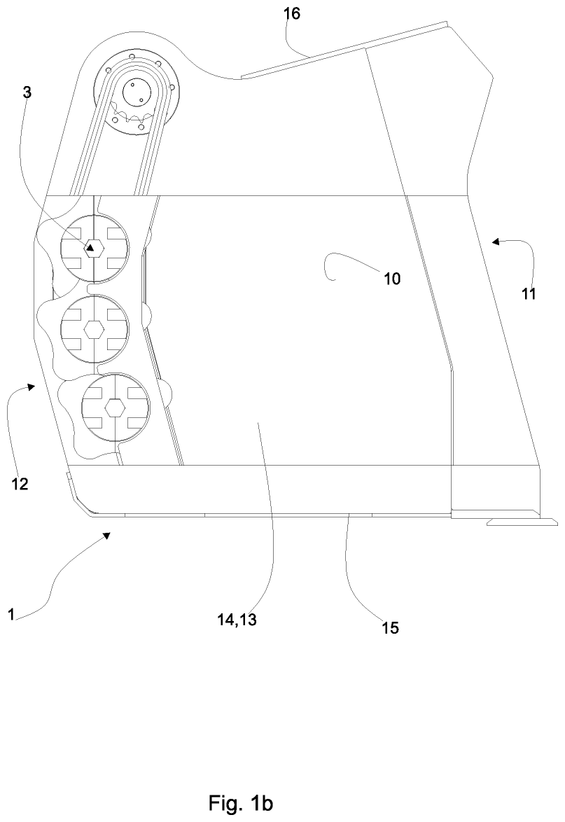

Finally, said method involves inserting the second half-clamp 72 and locking it to the first half-clamp 71 by means of the clamping means 73, as depicted in FIGS. 1a, 1b.

Alternatively, said first half-clamps 71 may be inserted one on the first end portion 4 and one on the second end portion 5, so that they present the cavity 74 facing towards the inside of the inner chamber 10.

This makes it easier to mount the first half-clamps 71, which are simply placed from the outside so that they embrace the first end portion 4 and the second end portion 5. In this case there is no need to take care to position the secondary half-plates 75a of the first half-clamps 71 between the plates 35 of the adjacent drums 30 of the rotors 3 already installed.

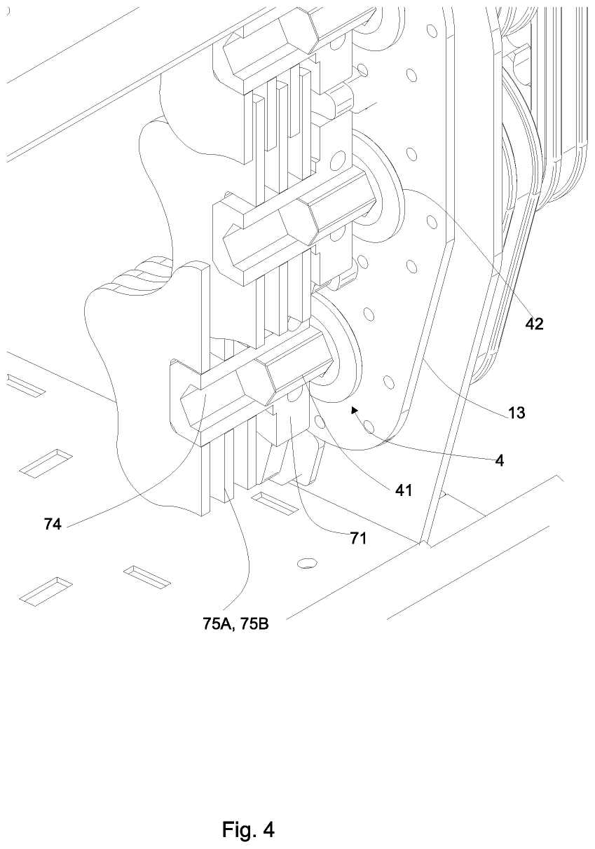

Preferably, they are then rotated by 180° so that the inner cavity 74 faces outwards of the inner chamber 10 as depicted in FIGS. 2a, 2b and 4.

The drum 30 is thus positioned so that the extensions 33, 34 are inserted into said first half-clamps 71, as depicted in FIG. 5.

Finally, said method involves inserting the second half-clamp 72 and locking it to the first half-clamp 71 by means of the clamping means 73, as depicted in FIGS. 1a, 1b.

Vice versa for disassembly.

Said disassembly method involves using the locking means 73 to disassemble the second half-clamp 72 and disconnect it from the first half-clamp 71.

The drum 30 is then disassembled so that the extensions 33, 34 disengage from said first half-clamps 71.

Finally, said method involves disassembling said first half-clamps 71 and disengaging them from the first end portion 4 and the second end portion 5.

To do this, since the first half-clamps 71 have the inner cavity 74 facing outwards of the inner chamber 10, to disassemble them they must be moved inwards towards the inner chamber 10 until the secondary half-plates 75a of the first half-clamps 71 slide off the plates 35 of the adjacent drum 30.

Alternatively, said first half-clamps 71 are rotated by 180° so as to turn the inner cavity 74 towards the inside of the inner chamber 10 and allow them to be more easily moved towards the outside of the inner chamber 10. In such a case, it is not necessary to take care to remove the secondary half-plates 75a of the first half-clamps 71, from the plates 35 of the adjacent drums 30.

Therefore, thanks to this solution, the first end portion 4 and the second end portion 5 always remain mounted on the body 1 and do not need to be disassembled to extract the drum 30 from the bucket 100.

For the removal of the drum 30, only the connection element 7 and in particular only the second half-clamp 72 must be disassembled.

It in any case is intended for that described above to be given by way of non-limiting example; therefore possible detail variants that may be required for technical and/or functional reasons are considered from now as to fall within the same protective scope defined by the claims below.

1. A bucket (100) for screening, and/or crushing and/or mixing and/or sorting, of an excavating or loading machine, the bucket comprising a containment body (1) for collecting and containing material to be treated, and a plurality of working rotors (3) through which the material to be treated passes, configured to rotate about the working rotors' axis of symmetry (X), by means of power transmission means (2), wherein said rotor (3) comprises a first and a second end portion (4, 5) mechanically integral with the body (1) of which at least one is operatively connected to the power transmission means (2) and further comprises a screening drum (30) removably connected to said first and second end portions (4, 5).

2. The bucket (100) according to claim 1, wherein the rotor (3) comprises two connection elements (7) for mechanically blocking/releasing the screening drum (30) at the first and/or second end portions (4, 5), respectively.

3. The bucket (100) according to claim 1, wherein the containment body (1) comprises two side flanks (13, 14) and at least one lower wall (15) defining an inner chamber (10) for containing the material to be screened, said chamber (10) comprising an inlet opening (11) for receiving the material and an outlet opening (12) for discharging the material once screened.

4. The bucket (100) according to claim 1, wherein the screening drum (30) comprises a shaft (31) contained in the inner chamber (10) located near the outlet opening (12) and a plurality of plates (35) are installed on said shaft (31), at a constant pitch.

5. The bucket (100) according to claim 4, wherein the rotors (3) are arranged so that the plates (35) of each drum (30) interpenetrate with those of the adjacent drum (30).

6. The bucket (100) according to claim 4, wherein the shaft (31) comprises a central body (32) on which the plates (35) are installed and two lateral extensions (33, 34) which protrude from the outermost plates (35) and said lateral extensions (33, 34) have a smaller cross-section than the cross-section of the central body (32).

7. The bucket (100) according to claim 4, wherein said plates (35) comprise a plurality of lobes and in particular they comprise a central hole (37) configured to be threaded and positioned along the shaft 31.

8. The bucket (100) according to claim 4, wherein said plates (35) are threaded into the shaft (31), are mechanically blocked in the axial direction and spaced apart from each other by an intermediate insertion of a spacer (36) defining the pitch of said plates (35).

9. The bucket (100) according to claim 3, wherein the first and second end portions (4, 5) are passed through the side flanks (13, 14) extending both inside and outside the chamber (10).

10. The bucket (100) according to claim 3, wherein the first and second end portions (4, 5) comprise a pivot (41, 51) arranged passing through the side flank (13, 14) so as to extend both inside and outside the chamber (10) and supported by a bearing (42, 52) installed on the side flanks (13, 14) outside the chamber (10).

11. The bucket (100) according to claim 10, wherein the pivot (41, 51) is configured to be rotated by the power transmission means (2).

12. The bucket (100) according to claim 1, wherein the power transmission means (2), are installed on the containment body (1) and placed outside the inner chamber (10).

13. The bucket (100) according to claim 1, wherein the connecting element (7) is placed inside the chamber (10) and is a clamp (70) which can be opened into a first and a second half-clamp (71, 72) and configured to embrace the pivot (41, 51) and the facing extension (33, 34) of the shaft (31).

14. The bucket (100) claim 13, wherein the clamp (70) comprises clamping means (73) for connecting and securing the first and second half-clamps (71, 72) to each other.

15. The bucket (100) according to claim 13, wherein the clamp (70) comprises an inner cavity (74) and comprises on its outside one or more secondary half-plates (75a, 75b), in pitch continuity with the plates (35).

16. The bucket (100) according to claim 15, wherein said secondary half-plates (75a, 75b), have the same shape as the plates (35), but are divided into two being installed on the first and second half-clamps (71, 72) of the opening clamp (70) respectively.

17. The bucket (100) according to claim 13, wherein the clamp (70) comprises two sections (70a, 70b) with different outer diameters and wherein the section with a larger outer diameter is arranged in the vicinity of side flanks (13, 14) of the containment body (1) and the section with a smaller outer diameter is configured for mounting the secondary half-plates (75a, 75b).

18. Method for mounting a drum (30) in the bucket (100) according to claim 1, comprising:
inserting two first half-clamps (71) one on the first end portion (4) and one on the second end portion (5),
positioning the drum (3) so that the extensions (33, 34) of the shaft (31) are inserted into each first half-clamp (71), and
positioning the second half-clamp (72) and locking it to the first half-clamp (71).

19. The method according to claim 18, wherein the first half-clamp (71) is inserted with the inner cavity (74) facing towards the inside of the inner chamber (10) and involves rotating it by 180° so that the inner cavity (74) faces outwards before the drum (3) is mounted.
